(19) United States
(12) Patent Application Publication
(10) Pub. No.: US 2017/0308370 A1
(43) Pub. Date: Oct. 26, 2017

(54) IMAGE PROCESSING APPARATUS AND CONTROL METHOD THEREOF

(71) Applicant: SAMSUNG ELECTRONICS CO., LTD., Suwon-si (KR)

(72) Inventor: Eun-sook SUNG, Yongin-si (KR)

(73) Assignee: SAMSUNG ELECTRONICS CO., LTD., Suwon-si (KR)

(21) Appl. No.: 15/468,737

(22) Filed: Mar. 24, 2017

(30) Foreign Application Priority Data
Apr. 26, 2016 (KR) 10-2016-0051042

(51) Int. Cl. G06F 9/445; H04M 1/725; G06F 11/07

(52) U.S. Cl. CPC G06F 8/65; H04M 1/72583; H04M 1/7253; G06F 11/0793; G06F 11/0733; G06F 11/0769; G06F 11/0751; G06F 11/079

(57) ABSTRACT

An image processing apparatus includes a communicator configured to communicate with a server, a user input configured to receive a user's input, a storage configured to store software for operating the image processing apparatus, and a processor configured to determine whether the software stored in the storage is required to be updated in response to the user's input to the user input of making a request for a user support service about the image processing apparatus, to update the stored software with update software provided by the server if it is determined that the software needs to be updated, and to process the user support service if it is determined that the software does not need to be updated.

### CROSS-REFERENCE TO RELATED APPLICATIONS

This application claims priority from Korean Patent Application No. 10-2016-0051042 filed on Apr. 26, 2016, in the Korean Intellectual Property Office, the disclosure of which is incorporated herein by reference, in its entirety.

### BACKGROUND

### 1. Field

Apparatuses and methods related to the exemplary embodiments disclosed herein relate to an image processing apparatus for processing an image signal to be displayed as an image and a control method thereof, and more particularly to an image processing apparatus and a control method thereof, which can save resources needed to perform a remote management service for a repair if failure occurs while the image processing apparatus is in use.

### 2. Description of the Related Art

To compute and process predetermined information in accordance with certain processes, an electronic apparatus basically includes a central processing unit (the CPU), a chipset, a memory, and the like electronic components for computation. Such an electronic apparatus may be classified variously in accordance with what information will be processed therein. For example, the electronic apparatus is classified into an information processing apparatus such as a personal computer, a server or the like for processing general information, and an image processing apparatus for processing image information.

The image processing apparatus receives a content signal including video data from the exterior and processes the video data extracted from the content signal in accordance with various video processing processes. The image processing apparatus may display an image based on the processed video data on its own display panel, or output the processed video data to another display apparatus provided with a panel so that on the corresponding display apparatus can display an image based on the processed image signal. As a representative of the image processing apparatus that has no display panel, there is a set-top box. The image processing apparatus that has a display panel is called a display apparatus, and may for example include a TV, a monitor, a portable multimedia player (PMP), a tablet computer, a mobile phone, etc.

A failure may occur from many causes while the image processing apparatus is in use. Since a failure occurs in one of hardware and software of the image processing apparatus, a manufacturer of the image processing apparatus provides a support platform and a support service to repair the failure when receiving a failure report of the image processing apparatus from a user. As one of these services, if a user talks and reports information about the failure to a service provider, which provides a service for repairing the failure of the image processing apparatus, through a phone call or the like contact method, the service provider may remotely access the image processing apparatus through a network or may directly visit the user and check and repair the image processing apparatus.

However, if the service provider directly talks with many users to process all the failure reports received from the users, it is wasteful for both the service provider and the users in light of time, costs and manpower. In particular, a user often does not know the structure of the image processing apparatus well, and it is thus not easy for the service provider to get accurate information about the failure from the user while talking with the user.

Therefore, in terms of providing a service for repairing failure of the image processing apparatus, there may be a need of saving service resources required in direct talking between a user and a service provider.

### SUMMARY

Additional aspects and/or advantages will be set forth in part in the description which follows and, in part, will be apparent from the description, or may be learned by practice of the disclosure.

According to an aspect of an exemplary embodiment, there is provided an image processing apparatus including: a communicator configured to communicate with a server, a user input configured to receive a user's input, a storage configured to store software for operating the image processing apparatus, and a processor configured: to determine whether the software stored in the storage is required to be updated in response to the user's input to the user input of making a request for a user support service about the image processing apparatus, to update the stored software with update software provided by the server if it is determined that the software needs to be updated, and to process the user support service if it is determined that the software does not need to be updated. Thus, the image processing apparatus checks a version of software before performing a user support service in response to a request for the user support service because of failure, and then performs update, thereby preventing resources from being wasted for the user support service.

The processor may be configured to compare a version number of the software and a version number of the update software to determine whether the software is of a latest version, and to determine that the software is required to be updated if it is determined that the software is not of the latest version. Thus, the image processing apparatus easily determine whether the software is of the latest version.

The image processing apparatus may further include a display, the processor may process to display a user interface (UI) for allowing a user to select whether to perform the update on the display if it is determined that the update is required, may update the software if it is selected to perform the update through the UI, and may process the user support service if it is selected not to perform the update through the UI. Thus, the image processing apparatus reflects a user's intention to selectively provide the update of the software or the processes of the user support service.

The image processing apparatus may further include a display, the processor may process to display a UI for allowing a user to input information about failure in the image processing apparatus on the display when the user support service is processed, and may process to transmit the information input through the UI to the server. Thus, the image processing apparatus can efficiently process the user support service.

The UI may be provided to input information about a phone number of the user, so that a provider of the user support service can have contact with the user of the image processing apparatus. Thus, the image processing apparatus allows the provider of the user support service to directly talk with a user.

The processor may process to transmit the information about a phone number of the provider of the user support service to a phone when the user support service is processed, so that the phone can automatically dial the phone number. Thus, the image processing apparatus allows a user to easily talk with the provider of the user support service at the user support service.

The processor may process to determine a period of time between a point of time at which the user's input is made and a point of time at which a user's previous input of making a request for the user support service, which is closest in time to the user's input, is made, in response to the user's input, and the processor may process the user support service without determining whether the software is required to be updated if the determined period of time is smaller than a preset value. Thus, the image processing apparatus skips a wasteful operation of checking whether the software that has already been updated is required to be updated or not.

The software stored in the storage may be divided into a plurality of modules respectively corresponding to a plurality of functions, and the processor may process to determine a function related to failure in the image processing apparatus among the plurality of functions, and processes to selectively update the module corresponding to the determined function among the plurality of modules. Thus, the image processing apparatus decreases the amount of data needed for the update.

According to an aspect of an exemplary embodiment, there is provided a method of controlling an image processing apparatus, the method including: receiving a user's input of making a request for a user support service about the image processing apparatus, determining whether software for operating the image processing apparatus is required to be updated in response to the user's input, updating the software with update software provided by a server if it is determined that the software needs to be updated, and processing the user support service if it is determined that the software does not need to be updated. Thus, the image processing apparatus checks a version of software before performing a user support service in response to a request for the user support service because of failure, and then performs update, thereby preventing resources from being wasted for the user support service.

The determining whether software for operating the image processing apparatus is required to be updated may include: comparing a version number of the software and a version number of the update software to determine whether the software is of a latest version, and determining that the software is required to be updated if it is determined that the software is not of the latest version. Thus, the image processing apparatus easily determine whether the software is of the latest version.

The updating the software may include: displaying a UI for allowing a user to select whether to perform the update if it is determined that the update is required, updating the software if it is selected to perform the update through the UI, and processing the user support service if it is selected not to perform the update through the UI. Thus, the image processing apparatus reflects a user's intention to selectively provide the update of the software or the processes of the user support service.

The processing the user support service may include: displaying a UI for allowing a user to input information about failure in the image processing apparatus, and transmitting the information input through the UI to the server. Thus, the image processing apparatus can efficiently process the user support service.

The UI may be provided to input information about a phone number of the user, so that a provider of the user support service can have contact with the user of the image processing apparatus. Thus, the image processing apparatus allows the provider of the user support service to directly talk with a user.

The processing the user support service may include transmitting the information about a phone number of the provider of the user support service to a phone when the user support service is processed, so that the phone can automatically dial the phone number. Thus, the image processing apparatus allows a user to easily talk with the provider of the user support service at the user support service.

The method may further include: determining a period of time between a point of time at which the user's input is made and a point of time at which a user's previous input of making a request for the user support service, which is closest in time to the user's input, is made, in response to the user's input, and processing the user support service without determining whether the software is required to be updated if the determined period of time is smaller than a preset value. Thus, the image processing apparatus skips a wasteful operation of checking whether the software that has already been updated is required to be updated or not.

The software stored in the storage may be divided into a plurality of modules respectively corresponding to a plurality of functions, and the method may further include determining a function related to failure in the image processing apparatus among the plurality of functions, and selectively updating the module corresponding to the determined function among the plurality of modules. Thus, the image processing apparatus decreases the amount of data needed for the update.

### BRIEF DESCRIPTION OF THE DRAWINGS

The above and/or other aspects and advantages will become apparent and more readily appreciated from the following description of exemplary embodiments, taken in conjunction with the accompanying drawings, in which:

FIG. 1 illustrates a platform of providing a failure repairing service for an image processing apparatus according to the first exemplary embodiment;

FIG. 2 is a block diagram of the image processing apparatus according to the first exemplary embodiment;

FIG. 3 illustrates an interface for allowing a user to make an event for reporting a failure in the image processing apparatus according to the first exemplary embodiment;

FIG. 4 illustrates a user interface (UI) displayed on the image processing apparatus according to the first exemplary embodiment in response to the failure reporting event;

FIG. 5 is a block diagram of showing a principle of updating first software in the image processing apparatus according to the first exemplary embodiment;

FIG. 6 illustrates a UI displayed on the image processing apparatus according to the first exemplary embodiment in response to the failure reporting event;

FIG. 7 is a flowchart of controlling the image processing apparatus according to the first exemplary embodiment;

FIG. 8 illustrates a structure of software stored in an image processing apparatus according to the second exemplary embodiment;

FIG. 9 illustrates a UI for allowing a user to select a cause of a failure in the image processing apparatus according to the second exemplary embodiment;

FIG. 10 is a flowchart of controlling the image processing apparatus according to the second exemplary embodiment; and

FIG. 11 is a flowchart of controlling an image processing apparatus according to the third exemplary embodiment.

### DETAILED DESCRIPTION

Reference will now be made in detail to example embodiments which are illustrated in the accompanying drawings, wherein like reference numerals refer to like elements throughout. The embodiments are described below to explain the disclosure by referring to the figures.

Below, exemplary embodiments will be described in detail with reference to accompanying drawings. The following descriptions of the exemplary embodiments are made by referring to elements shown in the accompanying drawings, in which like numerals refer to like elements having substantively the same functions.

In the description of the exemplary embodiments, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the disclosure.

Further, the exemplary embodiments will describe elements directly related to the disclosure, and description of the other elements will be omitted. However, it will be appreciated that the elements, the descriptions of which are omitted, are not unnecessary to realize the apparatus or system according to the exemplary embodiments. In the following descriptions, terms such as “include” or “have” refer to presence of features, numbers, steps, operations, elements or combination thereof, and do not exclude presence or addition of one or more other features, numbers, steps, operations, elements or combination thereof.

Further, the embodiments respectively described with reference to the accompanying drawings are not exclusive to each other unless otherwise mentioned, and a plurality of embodiments may be selectively combined within one apparatus. The combination of these plural embodiments may be discretionally selected and applied to realize the inventive concept by a person having an ordinary skill in the art.

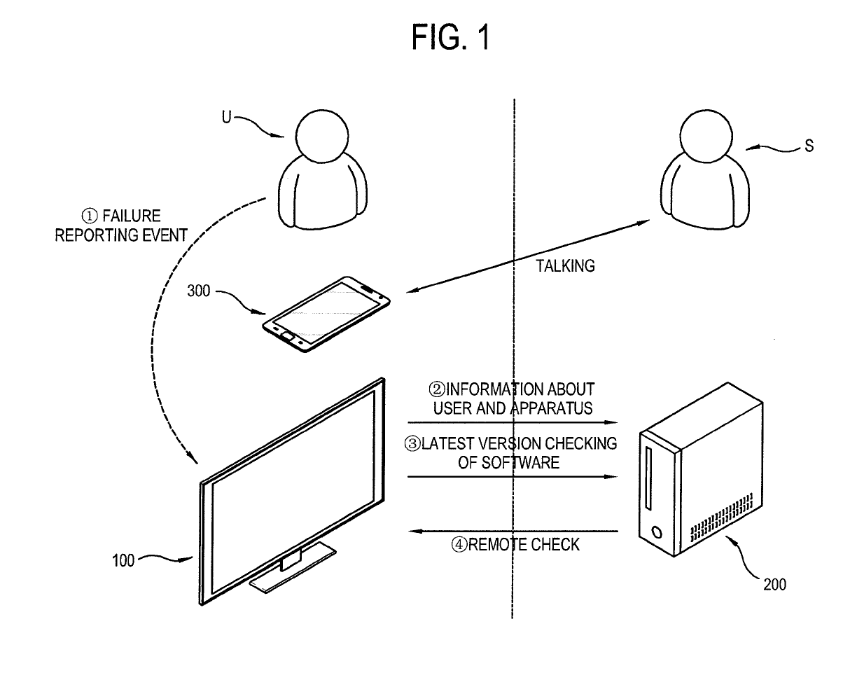

FIG. 1 illustrates a platform of providing a failure repairing service for an image processing apparatus 100 according to the first exemplary embodiment;

As shown in FIG. 1, the image processing apparatus 100 according to the first exemplary embodiment has an access to and communicates with one or more servers 200 through a network. The server 200 is provided and managed by a service provider S of supporting a failure repairing service of the image processing apparatus 100.

If failure occurs in the image processing apparatus 100 by a certain cause, a user U of the image processing apparatus 100 makes a direct call to and talks about the failure with the service provider S through a wired telephone or a mobile phone 300. However, this case is possible only when the user U already knows contact information of the service provider S.

Alternatively, a user U may generate a failure report event through an input interface (not shown) provided in the image processing apparatus 100. In this case, the image processing apparatus 100 transmits simple information about a user U and the image processing apparatus 100 to the server 200. As an example of such information, there are a phone number of a mobile phone 300 to which the service provider S makes a phone call for a user U, a model number of specifying the model of the image processing apparatus 100, etc. The service provider S makes connection with and talks with a user U in accordance with information received in the server 200.

Through a conversation, a user U informs the service provider S of the failure in the image processing apparatus 100.

The service provider S accesses the image processing apparatus 100 through the server 200 and checks the state of the image processing apparatus 100, based on information acquired from a user U. In accordance with results of checking the image processing apparatus 100, the service provider S may repair the failure in the image processing apparatus 100 by remotely modifying software of the image processing apparatus 100, by directly repairing the image processing apparatus 100, and so on.

In the foregoing description, only the service for repairing the failure in the image processing apparatus 100 is described. However, the service provided by the service provider S to a user U is not limited to the failure repairing service. The failure repairing service may be one of various kinds of user support services that can be provided by the service provider S. Alternatively, the inventive concept may be applied to not only the failure repairing service but also the other various services of the user support services.

Thus, processes of a conventional failure repairing service performed in response to the failure report event includes an operation of inputting preliminary information by a user through a UI, an operation of transmitting the input preliminary information by the image processing apparatus 100 to a server of the service provider, an operation of making connection with and talking with a user by the service provider based on the preliminary information received in the server, an operation of repairing the failure in the image processing apparatus 100 by the service provider in accordance with the talking results, and so on.

By the way, causes of failure in the image processing apparatus 100 may be roughly categorized into two types: failure in hardware of the image processing apparatus 100 and failure in software of the image processing apparatus 100. In the former case, the hardware needs to be repaired or replaced, and therefore the service provider has to visit a user or the user has to take the image processing apparatus 100 to the service provider. Therefore, in the former case, the foregoing processes of the failure repairing service are performed.

On the other hand, in the latter case, most of failures are repaired by just updating the software of the image processing apparatus 100. For example, the software of the image processing apparatus 100 refers to system software where firmware, a driver, an operating system, an application, etc. are packaged, and the server of the service provider stores and provides the system software of the latest version improved from the system software of the old version.

Functions that are required of the image processing apparatus 100 have become gradually complicated in accordance with development of technology, convenience in use, etc., and content reproduced in the image processing apparatus 100 also have various kinds and formats. Accordingly, software installed in the image processing apparatus 100 when the image processing apparatus 100 is released may not keep up with change in execution environment as time goes on. Therefore, the service provider improves and upgrades the software in accordance with the change in the execution environment, and thus stores the improved software of the latest version in the server.

If the failure in the image processing apparatus 100 is caused by an error in software, it may be repaired by downloading software of the latest version from the server and updating the software of the image processing apparatus 100 with the downloaded software without wasting resources to perform the processes of the failure repairing service.

Thus, according to the first exemplary embodiment, the image processing apparatus 100 performs a new operation as follows at a point of time before the conventional talking operation. The new operation to be described below may be performed after the image processing apparatus 100 transmits the input preliminary information to the server of the service provider or after the failure report event occurs.

As tasks performed in a background, the image processing apparatus 100 checks the software version of the image processing apparatus 100, performs the processes corresponding to the conventional case if it is checked that the software version is the latest version, and provides a user interface of guiding the software of the latest version to be installed if it is checked that the software version is not the latest version. Therefore, it is possible to minimize time to be taken in talking about a failure report, and minimize an error of the image processing apparatus 100 by the latest software reflecting items of which failure is repaired.

In this exemplary embodiment, detailed operations of checking and updating software will be described later.

Below, details of the image processing apparatus 100 will be described.

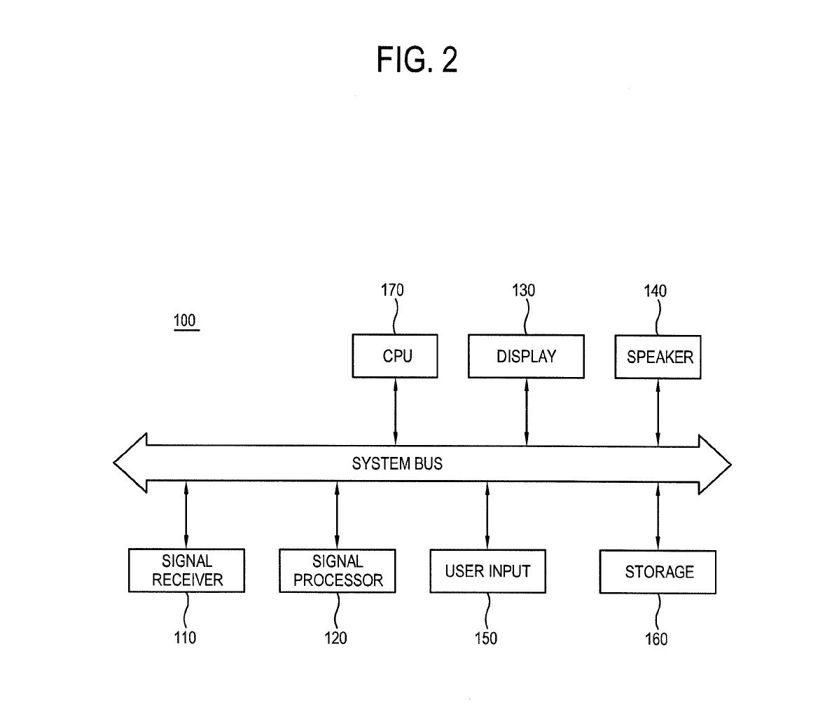

FIG. 2 is a block diagram of the image processing apparatus 100 according to the first exemplary embodiment.

As shown in FIG. 2, the image processing apparatus 100 in this exemplary embodiment is embodied by a TV. However, the image processing apparatus 100 may be embodied by various kinds of display apparatuses in addition to the TV. Alternatively, the image processing apparatus may be embodied by a set-top box or the like device having no display.

The image processing apparatus 100 includes a signal receiver 110 for receiving a broadcast signal in accordance with a broadcast or broadband network, a signal processor 120 for processing the broadcast signal received through the signal receiver 110, a display 130 for displaying a broadcast image corresponding to a specific channel of the broadcast signal processed by the signal processor 120, a loudspeaker 140 for outputting a broadcast sound corresponding to the specific channel of the broadcast signal processed by the signal processor 120, a user input 150 for allowing a user to make an input, a storage 160 for storing data, and a CPU 170 for executing computation for the processes of the signal processor 120 and operation control of the image processing apparatus 100. These elements are connected to one another through a system bus.

In this exemplary embodiment, the CPU 170 and the signal processor 120 are individually provided, but not limited thereto. In this exemplary embodiment, the CPU 170 and the signal processor 120 may be integrated into a single system on chip (SOC).

The signal receiver 110 receives a broadcast signal transmitted through the broadcast network. The signal receiver 110 is tuned to a frequency selected by the CPU 170 with respect to the broadcast signal. To this end, the signal receiver 110 includes a tuning chip to be tuned to a radio frequency (RF) signal. Further, the signal receiver 110 may receive a broadcast signal transmitted through the broadband network, and may for example receive packet data from a server (not shown) through the Internet. The signal receiver 110 supports at least one of a wired protocol and a wireless protocol. In the former case, the signal receiver 110 includes an Ethernet module. In the latter case, the signal receiver 110 includes a wireless communication module. In addition, the signal receiver 110 includes both the Ethernet module and the wireless communication module, thereby coping with both the wired protocol and the wireless protocol. For example, the wireless communication module may support a wireless fidelity (Wi-Fi) protocol.

Further, the signal receiver 110 may function as a communicator for interactive communication. For example, the signal receiver 110 may be provided to access a server (not shown) and exchange data with the server (not shown).

The signal processor 120 performs various processes with regard to a broadcast signal received in the signal receiver 110. The signal processor 120 extracts video data of a certain broadcast channel from a broadcast signal, performs a video processing process and outputs the processed video data to the display 130, so that the display 130 can display an image.

Since the signal processor 120 is provided to perform various processes depending on the kind or characteristic of signal or data, the processes to be performed in the signal processor 120 are not limited to the video processing process, and the data to be processed by the signal processor 120 is not limited to data received in the signal receiver 110. For example, the signal processor 120 performs an audio processing process with regard to audio data of a certain broadcast channel extracted from the broadcast signal, and outputs the processed audio data to the loudspeaker 140. Further, if a user's voice is input to the image processing apparatus 100, the signal processor 120 processes the voice in accordance with a preset voice recognition process. The signal processor 120 may be achieved by an SOC into which various functions are integrated, or an image processing board where individual chipsets for independently performing each process are mounted on to a printed circuit board.

The display 130 displays an image based on video data processed by the signal processor 120. There are no limits to the type of display 130. The display 130 may have a light receiving structure like a liquid crystal display (LCD) or a self-emissive structure like an organic light emitting diode (OLED). Further, the display 130 may include an auxiliary element in addition to a display panel in accordance with the types of display penal. For example, in case of the liquid crystal display (LCD), the display 130 includes a LCD panel (not shown), a backlight unit (not shown) for emitting light to the LCD panel (not shown), a panel driving substrate (not shown) for driving the LCD panel (not shown), etc.

The loudspeaker 140 outputs a sound based on audio data processed by the signal processor 120. The loudspeaker 140 vibrates air in accordance with an audio signal and thus changes air pressure, thereby outputting a sound. The loudspeaker 140 may include unit loudspeakers provided corresponding to audio data of a certain audio channel, and include a plurality of unit loudspeakers respectively corresponding to audio data of a plurality of audio channels.

The user input 150 transmits various preset control command or information to the CPU 170 or the signal processor 120 in response to a user's control or input. That is, the user input 150 transmits various events caused by a user's control to the CPU 170 or the signal processor 120 in accordance with a user's intention.

The user input 150 may be variously embodied in accordance with information input modes. For example, the user input 150 may include a key provided outside the image processing apparatus 100, a touch screen (not shown) provided in the display 130, a microphone for receiving a user's voice, a camera (not shown) for photographing or sensing external environments of the image processing apparatus 100, or the like user interface environment installed in the image processing apparatus 100. A remote controller (not shown) may be also regarded as one of the user interface environments. However, the remote controller (not shown) is separated from the main body of the image processing apparatus 100, and therefore a control signal is transmitted to the image processing apparatus 100 through a separate control signal receiver (not shown) provided in the main body of the image processing apparatus 100.

The storage 160 stores a variety of data under process and control of the CPU 170 and the signal processor 120. The storage 160 is accessed by the CPU 170 and performs reading, writing, editing, deleting, updating, etc. with regard to data. The storage 160 is achieved by a flash memory, a hard disc drive (HDD), a solid state drive (SSD), or the like nonvolatile memory for retaining data regardless of system power.

As an example of data stored in the storage 160, there is a channel map. If a user inputs a certain channel number through the user input 150, the CPU 170 searches the channel map stored in the storage 160 for a frequency value corresponding to the input channel number, and transmits the searched frequency value to the signal receiver 110. Thus, the signal receiver 110 is tuned to the frequency value received from the CPU 170 with respect to the broadcast signal.

The CPU 170 is an element for performing main calculation to operate general elements in the signal processor 120, which basically analyzes data and performs main calculation. The CPU 170 performs the calculation needed for operating the elements of the signal processor 120. In accordance with design of the signal processor 120, among the elements of the signal processor 120, there may be an element that operates without data calculation of the CPU 170 or by a separate microcontroller (not shown).

With this structure, the image processing apparatus 100 may display a UI, which allows a user to briefly input information about failure, in response to a failure report event when the failure report event occurs by the user. Below, such a UI will be described by way of example.

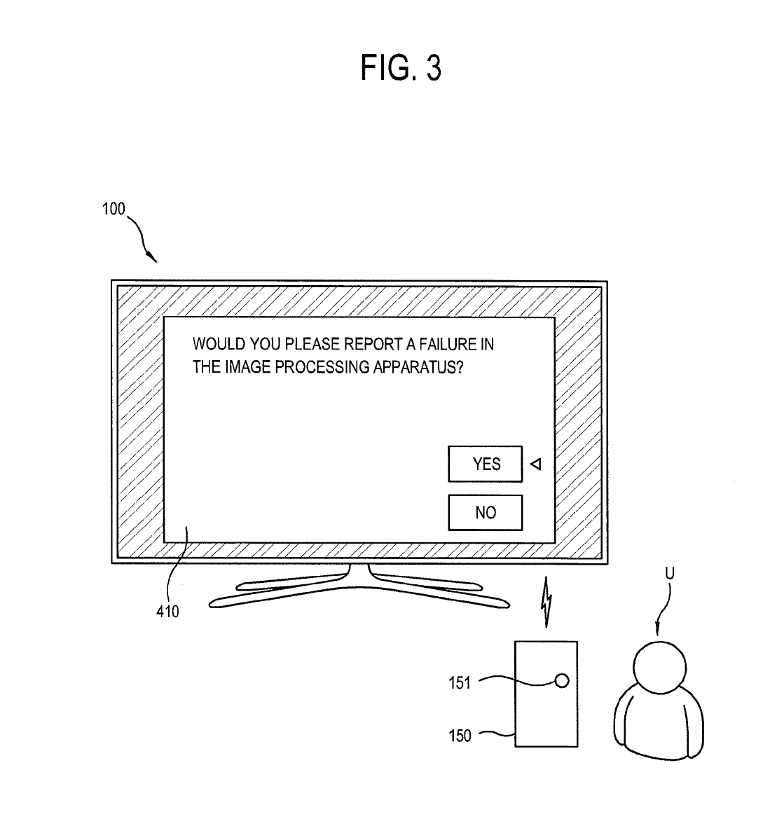

FIG. 3 illustrates an interface for allowing a user U to make an event for reporting a failure in the image processing apparatus according to the first exemplary embodiment.

As shown in FIG. 3, if a user thinks that a failure in the image processing apparatus 100 is caused by some reasons, the user may control a preset interface provided in the image processing apparatus 100 to thereby generate an event for reporting the failure in the image processing apparatus 100.

The failure report event may be generated in many ways. For example, the image processing apparatus 100 may display a user interface (UI) 410 for allowing a user to select the failure report event. If the user applies to report the failure through the UI 410, the image processing apparatus 100 determines that the failure report event occurs.

In addition, a remote controller 150 provided as one of the user inputs for the image processing apparatus 100 may include many keys. Among the keys, a key 151 may be provided corresponding to the failure report event. If a user U presses the key 151, a preset control signal corresponding to the key 151 is transmitted from the remote controller 150 to the image processing apparatus 100. The image processing apparatus 100 determines that the failure report event occurs if receiving such a control signal from the remote controller 150.

Besides, there are many ways of generating the failure report event.

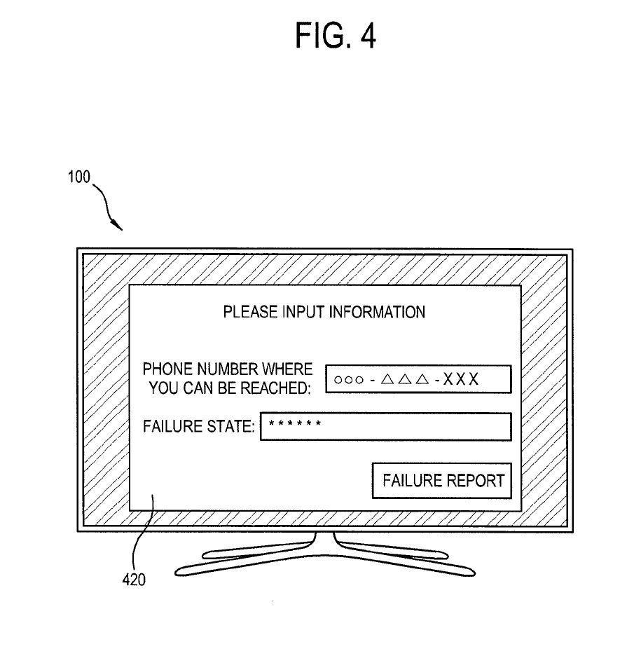

FIG. 4 illustrates a UI 420 displayed on the image processing apparatus 100 according to the first exemplary embodiment in response to the failure reporting event.

As shown in FIG. 4, the image processing apparatus 100 displays the UI 420 for an input of preliminary information to accept a failure report if sensing the occurrence of the failure report event.

The preliminary information to be input through the UI 420 may for example include a user's phone number at which the service provider can reach the user, a failure state of the image processing apparatus 100, etc. The user's phone number may be directly input by the user, or may be acquired from user profile information previously stored in the image processing apparatus 100. The failure state of image processing apparatus 100 may be directly input by a user, or may be given as some options selectable by the user on the UI 420.

Besides, the preliminary information that can be input through the UI 420 may include various pieces of information, for example, model information about a model of the image processing apparatus 100, location information about a location where the image processing apparatus 100 is installed, time information at which a user can be contacted by the service provider, etc.

The image processing apparatus 100 transmits the input preliminary information to the server of the service provider. The service provider contacts a user and talks about the failure report with the user in accordance with the preliminary information received from the image processing apparatus 100 to the server, and then repairs the failure in the image processing apparatus 100 through remote control using the server, a direct visit, etc. in accordance with talking results.

In the image processing apparatus 100 according to the first exemplary embodiment, detailed operations of checking software in response to the failure report of the image processing apparatus 100 will be described below.

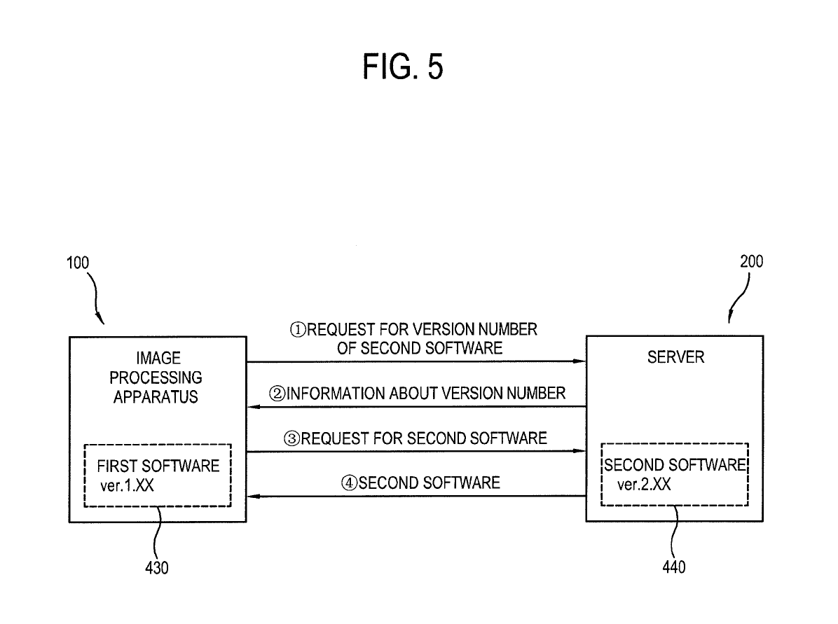

FIG. 5 is a block diagram of showing a principle of updating first software 430 in the image processing apparatus 100 according to the first exemplary embodiment.

As shown in FIG. 5, the image processing apparatus 100 stores the first software 430. Further, the server 200 that communicates with the image processing apparatus 100 stores second software 440. The first software 430 refers to software being currently stored and installed in the image processing apparatus 100, and the second software 440 refers to software prepared for updating the first software 430 of the image processing apparatus 100.

The first software 430 of the image processing apparatus 100 is updated as follows. The image processing apparatus 100 makes a request for a version number of the second software 440 provided by the server 200.

The server 200 gives the version number of the second software 440 to the image processing apparatus 100 in response to the request from the image processing apparatus 100.

The image processing apparatus 100 compares the version number of the first software 430 and the version number of the second software 440. As a comparison result, if the first software 430 and the second software 440 have the same version number, the image processing apparatus 100 determines that there are no needs of updating the first software 430 and does not perform the update.

On the other hand, as a comparison result, if the version number of the second software is newer than the version number of the first software, the image processing apparatus 100 determines that there is a need of updating the first software 430, and downloads and stores the second software 440, thereby updating the first software 430 with the second software 440.

By this method, the image processing apparatus 100 can update the first software 430.

The update of the first software 430 is periodically automatically performed by the image processing apparatus 100, or may be performed as designated by a user through the UI provided by the image processing apparatus 100. However, this method is inconvenient since the update for the first software 430 is not performed if automatic update settings are turned off, and a user has to make inputs one by one for designating the update.

In this exemplary embodiment, the update of the first software 430 is performed in response to not an input intended by a user but an input for reporting a failure in the image processing apparatus 100. This method operates even though the automatic update settings for the first software 430 are turned off in the image processing apparatus 100.

In other words, if a failure occurs in the image processing apparatus 100 in this exemplary embodiment, the image processing apparatus 100 tries repairing the failure by updating the first software 430 before carrying out the cumbersome processes of the failure repairing service. If the failure is not repaired by such an updating method, the failure repairing service has to be performed. On the other hand, if the failure is repaired by the updating method, the repair of the image processing apparatus 100 is easy since the failure repairing service is not performed.

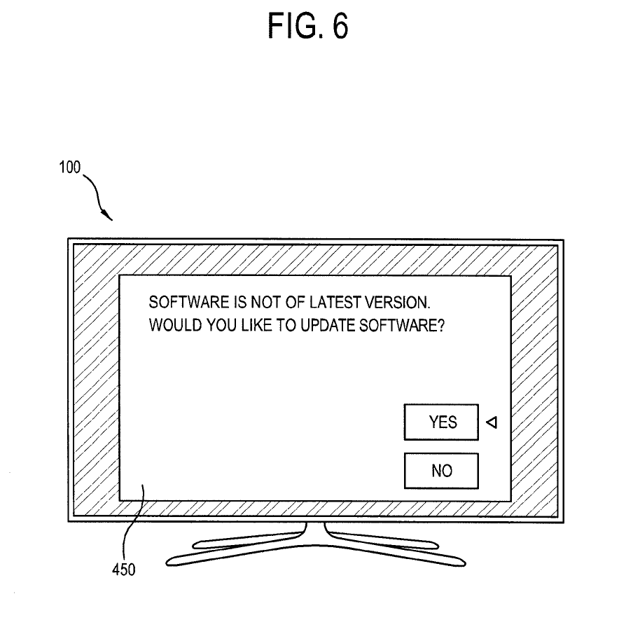

FIG. 6 illustrates a UI 450 displayed on the image processing apparatus according to the first exemplary embodiment in response to the failure reporting event.

As shown in FIG. 6, the image processing apparatus 100 first checks the version number of the previously stored software of the image processing apparatus 100 if it is determined that a user generates the failure report event. Here, the software generally refers to an integrated system software for operating the image processing apparatus 100, but not limited thereto. Alternatively, the software may refer to a firmware, an operating system, an application, etc.

Based on the version number of the software, the image processing apparatus 100 determines whether the software is of the latest version or not. As described in the exemplary embodiment shown in FIG. 5, the determination is performed by comparing the version number of the software with the version number of the software provided by the server.

If it is determined that the software is of the latest version, the image processing apparatus 100 proceeds with the failure-report receiving process as described in the first exemplary embodiment.

On the other hand, if it is determined that the software is not of the latest version, the image processing apparatus 100 displays the UI 450 to inform a user that the update of the software is needed.

In response to the failure report event caused by a user, the UI 450 informs the user that the current software is not of the latest version and thus the update of the software is required. If the image processing apparatus 100 automatically updates the software without displaying the UI 450, a user cannot know whether and why the failure is repaired even though the failure is repaired by the update. Thus, the image processing apparatus 100 displays the UI 450 and informs the user that the software will be updated for repairing the failure.

In this exemplary embodiment, the UI 450 is provided so that the update of the software can be carried out in response to a user's instruction. If a user issues a command to start the update on the UI 450, the image processing apparatus 100 accesses the server and carries out the update of the software. On the other hand, if a user issues a command not to start the update on the UI 450, the image processing apparatus 100 enters the failure-report receiving process.

In brief, a failure in the image processing apparatus 100 may be caused by error in software error as well as damage in hardware. On the contrary to the latter case where the hardware of the image processing apparatus 100 has to be repaired or replaced by the service provider, the failure in the former case is likely to be repaired by just updating the software of operating the image processing apparatus 100 with the latest software provided by the service provider. In practice, most of failure reports received in the service provider are solved by just updating the software.

Therefore, the image processing apparatus 100 according to this exemplary embodiment does not directly proceed with the processes of the failure repairing service in response to a user's failure report event, but first determines whether the software of the image processing apparatus 100 is required to be updated with software of the latest version. Thus, the image processing apparatus 100 updates the software if it is determined that the update is needed, and proceeds with the process of the failure repairing service if it is determined that the update is not needed.

Thus, it is possible to skip the process of the failure repairing service with regard to the failure repairable by the update of the software, thereby preventing time, manpower, equipment and the like service resources of the user and the service provider from being wasted.

Below, a method of controlling the image processing apparatus according to an exemplary embodiment will be described.

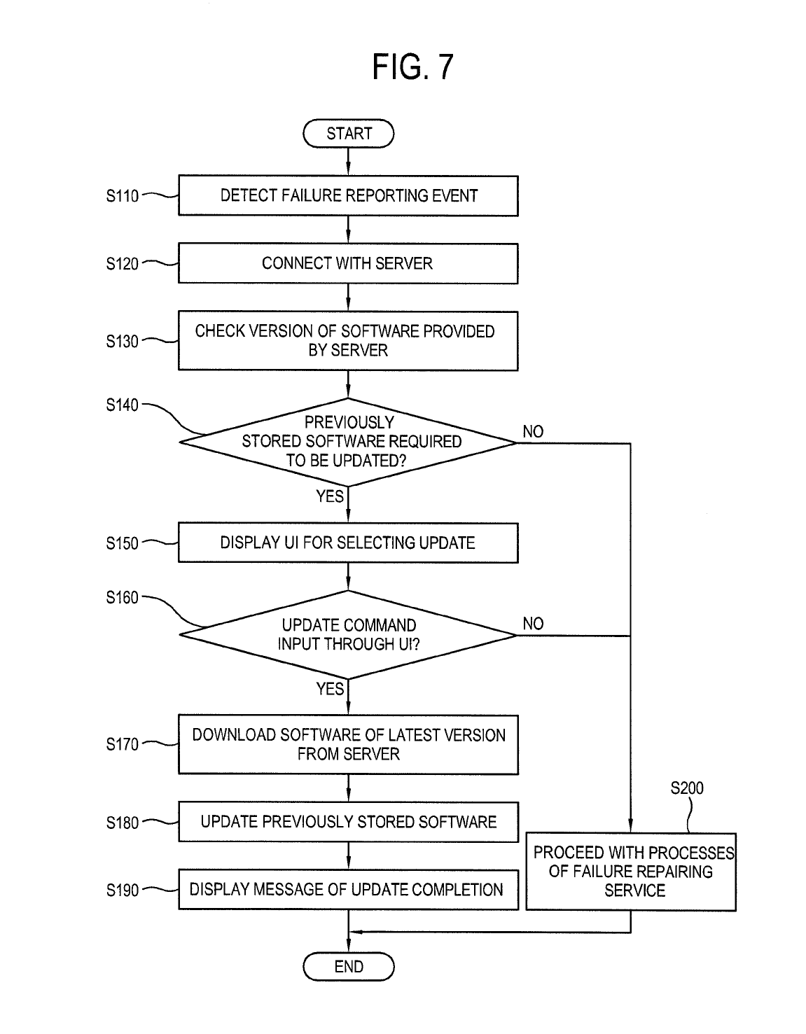

FIG. 7 is a flowchart of controlling the image processing apparatus according to the first exemplary embodiment.

As shown in FIG. 7, at operation S110 the image processing apparatus senses a failure report event.

At operation S120 the image processing apparatus accesses the server in response to the failure report event.

At operation S130 the image processing apparatus checks the version of the software provided by the server.

At operation S140 the image processing apparatus determines whether or not the previously stored software is required to be updated with that of the latest version. Here, the image processing apparatus proceeds with the processes of the operations S120 to S140 in a background. That is, the image processing apparatus may internally deal with the processes of the corresponding operations not to be recognized by a user while a predetermined content image is displayed.

If it is determined that the software is required to be updated with that of the latest version, that is, if the software is not of the latest version, at operation S150 the image processing apparatus displays the UI for allowing a user to select the update of the software.

At operation S160 the image processing apparatus determines whether an update command is input through the UI.

If the update command is input through the UI, at operation S170 the image processing apparatus downloads the latest software from the server. At operation S180 the image processing apparatus updates the previously stored software with the latest software downloaded from the server. At operation S190 the image processing apparatus displays an update completion message.

On the other hand, if it is determined in the operation S140 that the software is not required to be updated with that of the latest version, that is, if the software is of the latest version, or if the update command is not input through the UI in the operation S160, at operation S200 the image processing apparatus proceeds with the processes of the failure repairing service.

Thus, according to this exemplary embodiment, the processes of the failure repairing service are not performed in response to all the failure reports of various image processing apparatuses and are skipped with regard to the failure repairable by only the update of the software. Thus, it is possible to save the resources needed for the failure repairing service, and more quickly and simply provide the failure repairing service to a user.

By the way, in the state that it is determined to update the software in response to the failure report event, the image processing apparatus may have various ways of updating the software.

For example, the software of the image processing apparatus may include system software where various kinds of software such as a firmware, an operating system, a driver, a framework, an application, etc. are integrated and packaged. In this case, the software of the latest version provided by the server is also given as a package, and thus the image processing apparatus carries out the update by replacing the previously stored system software with system software downloaded from the server.

Further, the software of the image processing apparatus may be not the integrated system software but modularized corresponding to functions. Below, a method of updating the software modularized according to functions will be described.

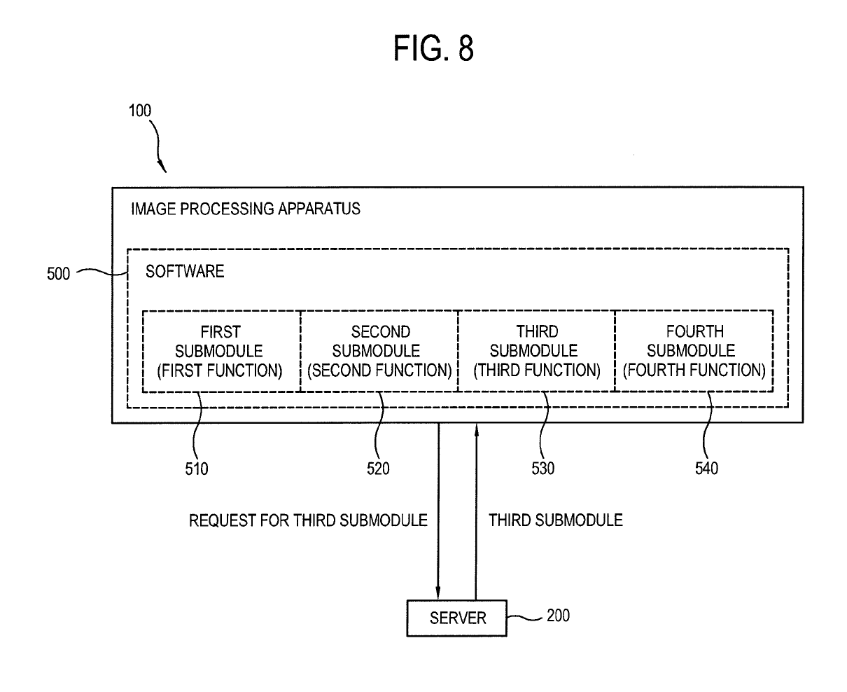

FIG. 8 illustrates a structure of software 500 stored in an image processing apparatus 100 according to the second exemplary embodiment.

As shown in FIG. 8, the software 500 for operations is stored and installed in the image processing apparatus 100 according to the second exemplary embodiment. The software 500 is modularized into a plurality of submodules 510, 520, 530 and 540 according to the functions to be implemented. For example, a first submodule 510 performs operations related to a preset first function, a second submodule 520 performs operations related to a preset second function, a third submodule 530 performs operations related to a preset third function, and a fourth submodule 540 performs operations related to a preset fourth function.

The image processing apparatus 100 may update the whole software 500, or may selectively update only some submodules 510, 520, 530, 540 of the software 500. In this case, the server 200 may be also provided to provide each submodule 510, 520, 530 or 540 of the latest version.

If it is determined that a specific submodule 510, 520, 530 or 540, e.g. the third submodule 530 needs to be updated, the image processing apparatus 100 makes a request for the third submodule 530 of the latest version to the server 200. Then, the server 200 transmits the third submodule 530 of the latest version to the image processing apparatus 100 in response to the request, the image processing apparatus 100 updates the previously stored third submodule 530 with that of the latest version.

Under the structure where the software 500 is divided into the plurality of submodules 510, 520, 530 and 540 according to functions, the image processing apparatus 100 can determine what failure is related to what function, i.e. what failure is related to what submodule 510, 520, 530 or 540.

In this regard, if a failure occurs in the image processing apparatus 100, the image processing apparatus 100 may selectively update only the submodule 510, 520, 530 or 540 related to the failure in the whole software 500. Advantageously, the amount of data to be updated in this case is relatively small and therefore quickly downloaded and updated.

To determine a cause of a failure, the image processing apparatus 100 may display a UI for a user's selection.

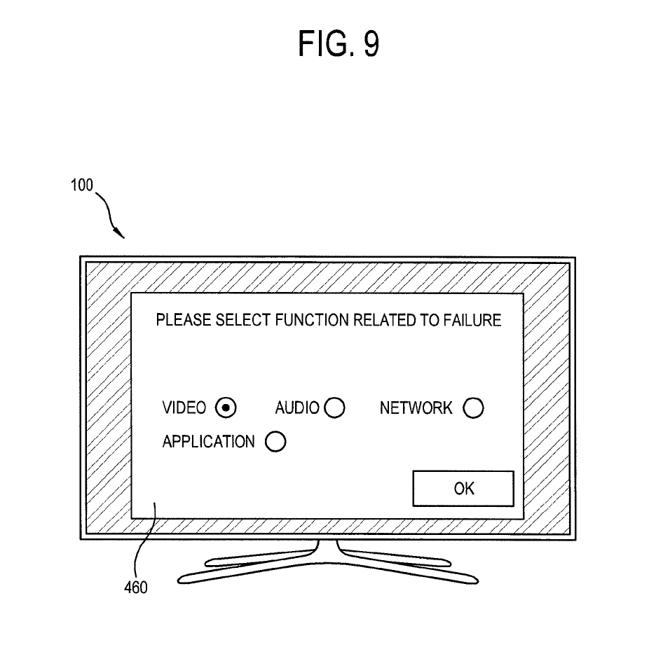

FIG. 9 illustrates a UI 460 for allowing a user to select a cause of a failure in the image processing apparatus according to the second exemplary embodiment.

As shown in FIG. 9, the image processing apparatus 100 displays the UI 460 for allowing a user to select what function is related to the failure, in response to the failure report event.

The UI 460 shows options for allowing a user to select at least one among a plurality of preset functions. For example, the plurality of functions is given as options related to video, audio, a network, an application, etc. so as to be easily recognizable by a user. For example, if an image is not normally reproduced, a user may select the option related to the video. If an image is normally reproduced but a sound is not output, a user may select the option related to the audio.

The image processing apparatus 100 may allow two or more options to be selectable on the UI 460.

The image processing apparatus 100 determines the submodule of the software corresponding to the function selected on the UI 460. The image processing apparatus 100 updates the determined submodule among all the submodules of the software and does not update the other submodules.

Thus, the image processing apparatus 100 according to an exemplary embodiment selectively updates only the submodule of the software, which is related to the failure. Accordingly, it is possible to decrease the amount of data needed for updating the software.

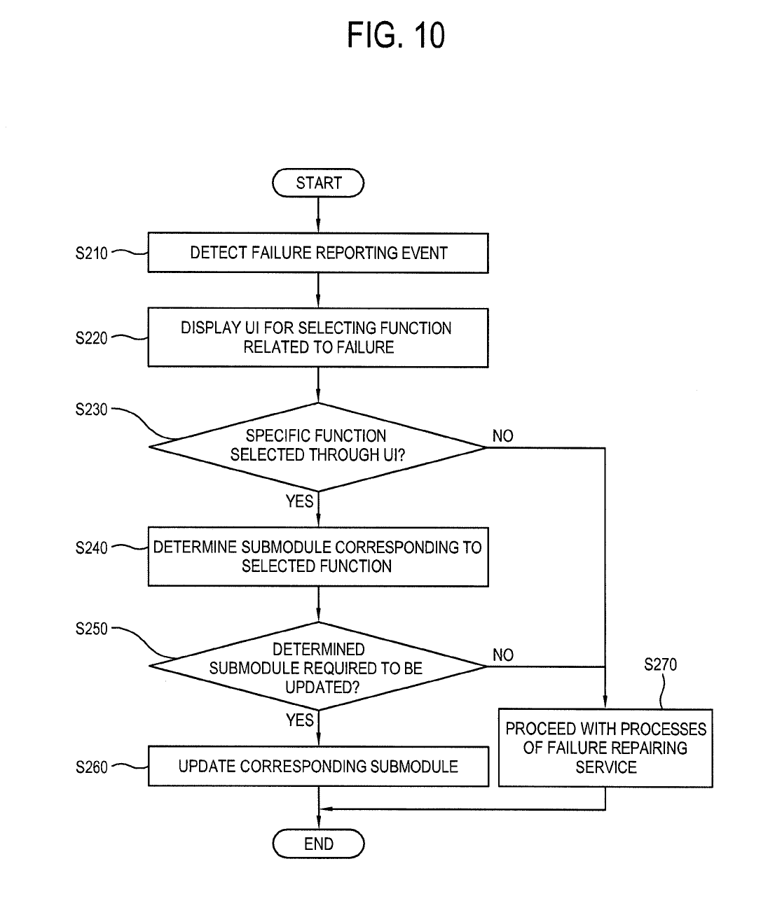

FIG. 10 is a flowchart of controlling the image processing apparatus according to the second exemplary embodiment.

As shown in FIG. 10, at operation S210 the image processing apparatus detects the failure report event.

At operation S220 the image processing apparatus displays a UI for allowing a user to select a function related to the failure.

At operation S230 the image processing apparatus determines whether a specific function is selected through the UI.

If the specific function is selected through the UI, at operation S240 the image processing apparatus determines the submodule of the software corresponding to the selected function.

At operation S250 the image processing apparatus determines whether the determined submodule is required to be updated.

If it is determined that the submodule needs to be updated, at operation S260 the image processing apparatus updates the submodule.

On the other hand, if it is determined in the operation S230 that any function is not selected through the UI or if it is determined in the operation S250 the submodule is not required to be updated, at operation S270 the image processing apparatus proceeds with the processes of the failure repairing service.

By the way, if the failure in the image processing apparatus is not repaired even after the image processing apparatus according to the first exemplary embodiment updates the software in response to the failure report event, a user may make the failure report event again. Below, an exemplary embodiment in this case will be described.

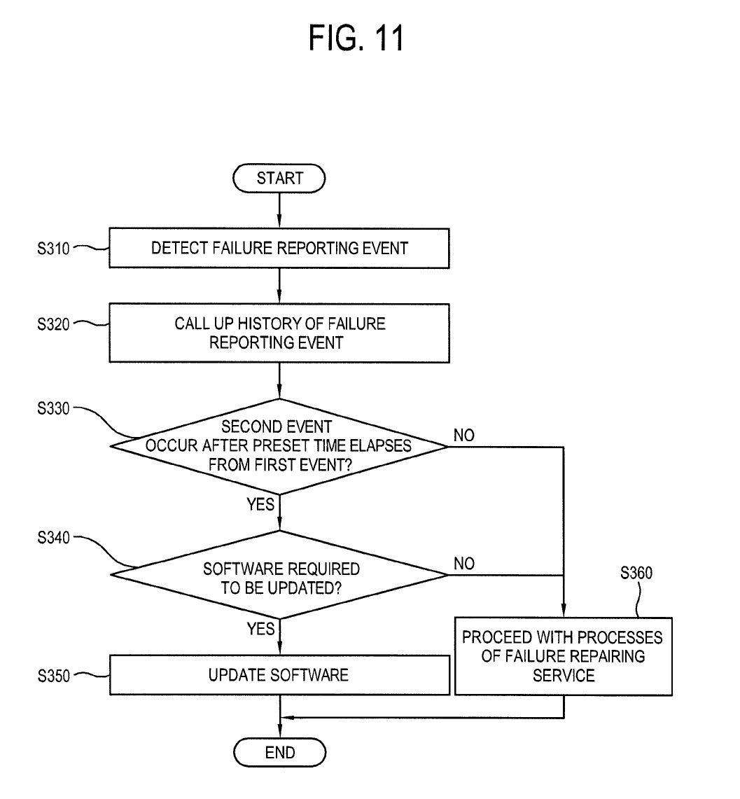

FIG. 11 is a flowchart of controlling an image processing apparatus according to the third exemplary embodiment.

As shown in FIG. 11, at operation S310 the image processing apparatus detects the failure report event.

At operation S320 the image processing apparatus calls up a history of failure report events. This history records points of time at which the events occur. For example, the failure report event detected in the operation S310 will be named a second event, and the closest failure report event to the second event in time among the failure report events recorded in the called history will be named a first event.

At operation S330 the image processing apparatus determines whether the second event occurs after a preset period of time elapses from the first event.

If it is determined that the second event occurs after the preset period of time elapses from the first event, at operation S340 the image processing apparatus determines whether the previously stored software is required to be updated.

If it is determined that the software needs to be updated, at operation S350 the image processing apparatus updates the software. The method of updating the software is equivalent to that of the foregoing exemplary embodiment, and thus repetitive descriptions thereof will be avoided.

On the other hand, if it is determined in the operation S330 that the second event occurs before the preset period of time elapses from the first event, or if it is determined in the operation S340 that the software is not required to be updated, at operation S360 the image processing apparatus proceeds with the processes of the failure repairing service.

In this exemplary embodiment, the meaning of the operation S330 is as follows. If the software is not of the latest version when the first event earlier than the second event is generated, the software will be updated. If the second event occurs before much time elapses from the first event, it is determined that there are two cases with regard to the cause of the failure corresponding to the second event. One case is that the cause of the failure at the second event is the same as the cause of the failure at the first event and not solved by the update of the software performed in response to the first event. The other case is that the cause of the failure at the second event is different from the cause of the failure at the first event. It is expected that these two cases are not solved by the update of the software.

Thus, the image processing apparatus directly proceeds with the processes of the failure repairing service without checking the version of the software if it is determined in the operation S330 that the second event occurs before the preset period of time elapses from the first event, i.e. difference in time between the second event and the first event is within the preset period of time. Thus, the image processing apparatus can skip wasteful processes of checking the version of the software.

In addition, when the image processing apparatus proceeds with the processes of the failure repairing service in the operation S360, there may be many kinds of processes. For example, as described in the foregoing exemplary embodiment, the image processing apparatus may display the UI for allowing a user to input simple preliminary information, and transmit the information input through the UI to the server of the service provider.

Further, the image processing apparatus may transmit a control signal including previously stored information about a phone number of the service provider to a mobile phone of a user, so that the mobile phone can make a phone call to the service provider in response to this control signal.

The methods according to the foregoing exemplary embodiments may be embodied in the form of a program command that can be implemented in various computers, and recorded in a computer readable medium. Such a computer readable medium may include a program command, a data file, a data structure or the like, or combination thereof. For example, the computer readable medium may be stored in a voltage or nonvolatile storage such as a read only memory (ROM) or the like, regardless of whether it is deletable or rewritable, for example, a RAM, a memory chip, a device or integrated circuit (IC) like memory, or an optically or magnetically recordable or machine (e.g., a computer)-readable storage medium, for example, a compact disk (CD), a digital versatile disk (DVD), a magnetic disk, a magnetic tape or the like. It will be appreciated that a memory, which can be included in a mobile terminal, is an example of the machine-readable storage medium suitable for storing a program having instructions for realizing the exemplary embodiments. The program command recorded in this storage medium may be specially designed and configured according to the exemplary embodiments, or may be publicly known and available to those skilled in the art of computer software.

Although exemplary embodiments have been shown and described, it will be appreciated by those skilled in the art that changes may be made to these exemplary embodiments without departing from the principles and spirit of the disclosure, the scope of which is defined in the appended claims and their equivalents.

What is claimed is:

1. An image processing apparatus, comprising:
a communicator configured to communicate with a server;
a user input configured to receive an input from a user;
a storage configured to store software for operating the image processing apparatus; and
a processor configured:
to determine whether the software stored in the storage needs to be updated in response to the input received from the user via the user input requesting a user support service regarding the image processing apparatus,
to update the software stored in the storage with update software provided by the server if the processor determines that the software needs to be updated, and
to process the user support service if the processor determines that the software does not need to be updated.

2. The image processing apparatus according to claim 1, wherein the processor is further configured to compare a version number of the software and a version number of the update software to determine whether the software is of a latest version, and to determine that the software needs to be updated if the processor determines the software is not of the latest version.

3. The image processing apparatus according to claim 1, further comprising a display,
wherein the processor is further configured:
to perform a process to display a user interface (UI) on the display for allowing a user to select whether to perform the update if the processor determines that the software needs to be updated,
to update the software if a selection to perform the update is made through the UI, and
to process the user support service if a selection not to perform the update is made through the UI.

4. The image processing apparatus according to claim 1, further comprising a display,
wherein the processor is further configured:
to perform a process to display a user interface (UI) on the display for allowing a user to input information about a failure in the image processing apparatus when the user support service is processed, and
to perform a process to transmit the information input through the UI to the server.

5. The image processing apparatus according to claim 4, wherein the UI is configured to enable information about a phone number of the user to be input, so that a provider of the user support service can contact the user of the image processing apparatus.

6. The image processing apparatus according to claim 1, wherein the processor is further configured to perform a process to transmit information about a phone number of the provider of the user support service to a phone associated with the image processing apparatus when the user support service is processed, so that the phone associated with the image processing apparatus can automatically dial the phone number of the provider of the user support service.

7. The image processing apparatus according to claim 1, wherein the processor is further configured:
to perform a process, in response to the input from the user via the user input requesting the user support service, to determine a period of time between a point of time at which the input from the user was received and a point of time at which a previous input to the user input requesting the user support service was received, and
to process the user support service without determining whether the software needs to be updated if the period of time is smaller than a preset value,
wherein the previous input is an input closest in time to the input from the user via the user input requesting the user support service, relative to other previous inputs requesting the user support service.

8. The image processing apparatus according to claim 1, wherein
the software stored in the storage is divided into a plurality of modules respectively corresponding to a plurality of functions, and
the processor is further configured to perform a process to determine one or more functions related to a failure in the image processing apparatus among the plurality of functions, and to perform a process to selectively update one or more modules among the plurality of modules corresponding to the one or more functions among the plurality of functions determined to be related to the failure in the image processing apparatus.

9. A method of controlling an image processing apparatus, the method comprising:
receiving an input from a user requesting a user support service regarding the image processing apparatus;
determining whether software for operating the image processing apparatus needs to be updated in response to receiving the input from the user requesting the user support service;
selectively updating the software with update software provided by a server if the determining determines that the software needs to be updated; and
processing the user support service if the determining determines that the software does not need to be updated.

10. The method according to claim 9, wherein the determining comprises:
comparing a version number of the software and a version number of the update software to determine whether the software is of a latest version; and
determining that the software needs to be updated if the software is not of the latest version.

11. The method according to claim 9, wherein the selectively updating the software comprises:
displaying a user interface (UI) for allowing a user to select whether to perform the updating of the software if the determining determines that the software needs to be updated;
updating the software if a selection to perform the update is made through the UI; and
processing the user support service if a selection not to perform the update is made through the UI.

12. The method according to claim 9, wherein the processing the user support service comprises:
displaying a user interface (UI) for allowing a user to input information about a failure in the image processing apparatus; and
transmitting the information input through the UI to the server.

13. The method according to claim 12, wherein the UI is configured to enable information about a phone number of the user to be input, so that a provider of the user support service can contact the user of the image processing apparatus.

14. The method according to claim 9, wherein the processing the user support service comprises transmitting information about a phone number of the provider of the user support service to a phone associated with the image processing apparatus when the user support service is processed, so that the phone associated with the image processing apparatus can automatically dial the phone number of the provider of the user support service.

15. The method according to claim 9, further comprising:
determining, in response to the input from the user requesting the user support service, a period of time between a point of time at which the input from the user was received and a point of time at which a previous input requesting the user support service was received; and
processing the user support service without determining whether the software needs to be updated if the period of time is smaller than a preset value,
wherein the previous input is an input closest in time to the input from the user via the user input requesting the user support service, relative to other previous inputs requesting the user support service.

16. The method according to claim 9, wherein
the software stored in the storage is divided into a plurality of modules respectively corresponding to a plurality of functions, and
the method further comprises:
determining one or more functions related to a failure in the image processing apparatus among the plurality of functions; and
selectively updating one or more modules among the plurality of modules corresponding to the one or more functions among the plurality of functions determined to be related to the failure in the image processing apparatus.
